(19) United States
(12) Patent Application Publication
(10) Pub. No.: US 2026/0031872 A1
(43) Pub. Date: Jan. 29, 2026

(54) COMMUNICATION METHOD AND TERMINAL DEVICE

(71) Applicant: BEIJING UNISOC COMMUNICATIONS TECHNOLOGY CO., LTD., Beijing (CN)

(72) Inventor: Huan ZHOU, Beijing (CN)

(21) Appl. No.: 18/997,397

(22) PCT Filed: Jul. 18, 2023
(86) PCT No.: PCT/CN2023/107868

§ 371 Date: Jan. 21, 2025

(30) Foreign Application Priority Data
Jul. 20, 2022 (CN) 202210852522.9

(51) Int. Cl. H04B 7/06; H04W 72/0453; H04W 72/0457

(52) U.S. Cl. CPC H04B 7/0626; H04W 72/0453; H04W 72/0457

(57) ABSTRACT

A communication method and a terminal device are provided. The method includes the following. A terminal device performs channel state information (CSI) measurement and/or CSI reporting according to a CSI reporting band, where the CSI reporting band is determined according to an active bandwidth part (BWP) and multiple frequency domain resources in a same time unit, and the multiple frequency domain resources include an uplink frequency domain resource and a downlink frequency domain resource.

### CROSS REFERENCE TO RELATED APPLICATION(S)

The present application is National Stage of International Application No. PCT/CN2023/107868, filed Jul. 18, 2023, which claims priority to Chinese Patent Application No. 202210852522.9, filed Jul. 20, 2022, which are incorporated herein by reference in their entireties.

### TECHNICAL FIELD

This application relates to the field of communication technology, and in particular to a communication method and a terminal device.

### BACKGROUND

Channel state information (CSI) is introduced in standard protocols specified by the 3rd generation partnership project (3GPP).

The CSI is used for the terminal device to feed back downlink channel quality to the network device, so that the network device can select a suitable modulation and coding scheme (MCS) for downlink data transmission to reduce a block error rate (BLER) of downlink data transmission, and perform corresponding beam management, mobility management, adaptive tracking, rate matching, and other processing.

However, with the evolution of standard protocols and communication scenarios, a new allocation manner of frequency domain resources may be introduced. How to perform CSI measurement and/or CSI reporting under the new allocation manner of frequency domain resources requires further study.

### SUMMARY

In a first aspect, a communication method is provided in the disclosure. The communication method includes the following. Channel state information (CSI) measurement and/or CSI reporting is performed according to a CSI reporting band, where the CSI reporting band is determined according to an active bandwidth part (BWP) and multiple frequency domain resources in a same time unit, and the multiple frequency domain resources include an uplink frequency domain resource and a downlink frequency domain resource.

In a second aspect, a communication method is provided in the disclosure. The communication method includes the following. A CSI report is received, where the CSI report is performed according to a CSI reporting band, the CSI reporting band is determined according to an active BWP and multiple frequency domain resources in a same time unit, and the multiple frequency domain resources include an uplink frequency domain resource and a downlink frequency domain resource.

In a third aspect, a terminal device is provided in the disclosure. The terminal device includes a processor and a memory configured to store computer programs or instructions, where the processor is configured to execute the computer programs or instructions to perform the method in the first aspect.

### BRIEF DESCRIPTION OF THE DRAWINGS

In order to more clearly illustrate the technical solutions in embodiments of the disclosure, the following briefly introduces drawings required in descriptions of embodiments or the prior art.

FIG. 1 is a schematic diagram of an architecture of a communication system according to embodiments of the disclosure.

FIG. 2 is a schematic diagram of a structure of multiple frequency domain resources in the same time unit according to embodiments of the disclosure.

FIG. 3 is a schematic diagram of a structure of an active BWP and multiple frequency domain resources in the same time unit according to embodiments of the disclosure.

FIG. 4 is a schematic diagram of a subband structure after each available frequency domain resource is independently divided into subbands according to embodiments of the disclosure.

FIG. 5 is a schematic diagram of a subband structure after multiple available frequency domain resources are jointly divided into subbands according to embodiments of the disclosure.

FIG. 6 is a schematic diagram of a subband structure after an unavailable frequency domain resource and an available frequency domain resource are divided into subbands according to embodiments of the disclosure.

FIG. 7 is a flowchart of a communication method according to embodiments of the disclosure.

FIG. 8 is a block diagram of functional units of a communication apparatus according to embodiments of the disclosure.

FIG. 9 is a block diagram of functional units of another communication apparatus according to embodiments of the disclosure.

FIG. 10 is a schematic diagram of the structure of a terminal device according to embodiments of the disclosure.

FIG. 11 is a schematic diagram of the structure of a network device according to embodiments of the disclosure.

### DETAILED DESCRIPTION

It should be understood that, the terms “first”, “second”, and the like used in embodiments of the disclosure are used to distinguish different objects rather than describe a particular order. In addition, the terms “include”, “comprise”, and “have” as well as variations thereof are intended to cover non-exclusive inclusion. For example, a process, method, software, product, or device including a series of steps or units is not limited to the listed steps or units, and instead, it can optionally include other steps or units that are not listed or other steps or units inherent to the process, method, product, or device.

The term “embodiment” referred to in embodiments of the disclosure means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

The term “and/or” in embodiments of the disclosure describes an association relationship between associated objects, and indicates that there may be three relationships, for example, A and/or B may mean A alone, both A and B exist, and B alone. A and B each may be a singular from or a plural form.

The character “/” in embodiments of the disclosure can indicate that the associated objects are in an “or” relationship. In addition, the symbol “/” may represent a divisor, i.e., perform a division operation. For example, A/B may represent A divided by B.

The term “at least one (item) of” or the like in embodiments of the disclosure refers to any combination of these items, including any combination of a single item or multiple items, and refers to one or multiple, where multiple refers to two or more. For example, at least one (item) of a, b, or c can represent the following seven cases: a; b; c; a and b; a and c; b and c; a, b, and c. a, b, and c each may be an element or a set including one or more elements.

The term “equal to” in embodiments of the disclosure may be used together with “greater than”, which is applicable to a technical solution used in a case of “greater than”; or may be used together with “less than”, which is applicable to a technical solution used in a case of “less than”. It should be noted that, when “equal to” is used together with “greater than”, “equal to” is not used together with “less than”; and when “equal to” is used together with “less than”, “equal to” is not used together with “greater than”.

The terms “of”, “corresponding/relevant”, and “indicated” in embodiments of the disclosure may be used interchangeably sometimes. It should be noted that meanings expressed by the terms are consistent when differences of the terms are not emphasized.

The term “connection” in embodiments of the disclosure refers to various connection methods, such as direct connection or indirect connection, so as to implement communication between devices, which is not limited herein.

The terms “network” and “system” in embodiments of the disclosure may refer to the same concept, and a communication system is a communication network.

The terms “size”, “length”, and the like in embodiments of the disclosure may refer to the same concept.

The terms “network” and “system” in embodiments of the disclosure may refer to the same concept, and a communication system is a communication network.

The terms “number”, “quantity”, and “amount” in embodiments of the disclosure may refer to the same concept.

The terms “reporting”, “report”, “feedback”, and the like in embodiments of the disclosure may refer to the same concept. In other words, terms “CSI report”, “CSI reporting”, “CSI feedback”, and the like may refer to the same concept.

The terms “contain”, “carry”, and “bear” in embodiments of the disclosure may refer to the same concept.

The terms “associated with”, “corresponding to”, “mapped to”, and the like in embodiments of the disclosure may refer to the same concept.

The terms “exclude”, “ignore”, “eliminate”, “skip”, “cancel”, “release”, and the like in embodiments of the disclosure may refer to the same concept.

The following describes relevant contents, concepts, meanings, technical problems, technical solutions, beneficial effects, and the like involved in embodiments of the disclosure.

### I. Communication System, Terminal Device, and Network Device

### 1. Communication System

The technical solutions of embodiments of the disclosure may be applicable to various communication systems, for example, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication System (UMTS), a wireless local area network (WLAN), a wireless fidelity (Wi-Fi), a 6th-generation (6G) communication system, or other communication systems.

It should be noted that, a conventional communication system generally supports a limited number (quantity) of connections and therefore is easy to implement. However, with the development of communication technology, a communication system will not only support a conventional communication system but also support, for example, device-to-device (D2D) communication, machine-to-machine (M2M) communication, machine-type communication (MTC), vehicle-to-vehicle (V2V) communication, vehicle to everything (V2X) communication, narrowband internet of things (NB-IOT) communication, etc. Therefore, the technical solutions of embodiments of the disclosure can also be applied to these communication systems.

In addition, the technical solutions of embodiments of the disclosure may be applied to a beamforming scenario, a carrier aggregation (CA) scenario, a dual connectivity (DC) scenario, or a standalone (SA) deployment scenario, etc.

In embodiments of the disclosure, a spectrum used for communication between a terminal device and a network device or a spectrum used for communication between a terminal device and a terminal device may be a licensed spectrum or an unlicensed spectrum, which is not limited herein. In addition, the unlicensed spectrum may be understood as a shared spectrum, and the licensed spectrum may be understood as an unshared spectrum.

Since various embodiments of the disclosure are described in connection with a terminal device and a network device, the terminal device and the network device involved will be described in detail below.

### 2. Terminal Device

The terminal device may be a device with transceiver functions, or may be referred to as a terminal, a user equipment (UE), a remote UE, a relay UE, an access terminal device, a subscriber unit, a subscriber station, a mobile station, a remote station, a mobile device, a user terminal device, a smart terminal device, a wireless communication device, a user agent, or a user apparatus. It should be noted that, a relay device is a terminal device capable of providing a relay forwarding service for other terminal devices (including a remote terminal device).

For example, the terminal device may be a mobile phone, a pad, a computer with wireless transceiver functions, a virtual reality (VR) terminal device, an augmented reality (AR) terminal device, a wireless terminal device in industrial control, a wireless terminal device in self-driving, a wireless terminal device in remote medicine, a wireless terminal device in smart grid, a wireless terminal device in transportation safety, a wireless terminal device in smart city, or a wireless terminal device in smart home, etc.

For another example, the terminal device may also be a cellular radio telephone, a cordless telephone, a session initiation protocol (SIP) telephone, a wireless local loop (WLL) station, a personal digital assistant (PDA), various devices having wireless communication functions such as a handheld device, a computing device or other processing devices coupled with a wireless modem, an in-vehicle device, a wearable device, a terminal device in a next-generation communication system (such as an NR communication system, a 6G communication system), or a terminal device in a future evolved public land mobile network (PLMN), etc., which is not limited herein.

In some possible implementations, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In some possible implementations, the terminal device may include a device with wireless communication functions, such as a system-on-chip (SOC), a chip, a chip module, etc. Exemplarily, the SOC may include a chip, or may also include other discrete components.

### 3. Network Device

The network device may be a device with transceiver functions for communicating with the terminal device.

In some possible implementations, the network device may be responsible for radio resource management (RRM), quality of service (QOS) management, data compression and encryption, and data transmission and reception at an air-interface side.

In some possible implementations, the network device may be a base station (BS) in a communication system or a device deployed on a radio access network (RAN) for providing wireless communication functions.

For example, the network device may be an evolutional node B (eNB or eNodeB) in an LTE communication system, a next-generation evolved node B (ng-eNB) in an NR communication system, a next-generation node B (gNB) in an NR communication system, a master node (MN) in a DC architecture, a secondary node (SN) in a DC architecture, etc, which is not limited herein.

In some possible implementations, the network device may also be a device in a core network (CN), such as an access and mobility management function (AMF), a user plane function (UPF), etc., or may be an access point (AP) in a WLAN, a relay station, a communication device in a future evolved PLMN, a communication device in an NTN network, etc.

In some possible implementations, the network device may include an apparatus for providing wireless communication functions for the terminal device, such as an SOC, a chip, a chip module, etc. Exemplarily, the SOC may include a chip, or may include other discrete components.

In some possible implementations, the network device may communicate with an internet protocol (IP) network, for example, the Internet, a private IP network, or other data networks.

In some possible implementations, the network device may be an independent node so as to implement functions of the base station, or the network device may include two or more independent nodes to implement functions of the base station. For example, the network device includes a centralized unit (CU) and a distributed unit (DU), such as a gNB-CU and a gNB-DU. Further, in some other embodiments of the disclosure, the network device may further include an active antenna unit (AAU). The CU can implement some functions of the network device, and the DU can implement some other functions of the network device. For example, the CU is responsible for processing non-real-time protocols and services, and implements functions of a radio resource control (RRC) layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a media access control (MAC) layer, and functions of a PHY layer. In addition, the AAU can implement some PHY layer processing functions, radio frequency (RF) processing functions, and active-antenna-related functions. Since RRC layer information will eventually become PHY layer information, or be transformed from PHY layer information, in such network deployment, it may be considered that higher-layer signaling, such as RRC signaling, is transmitted by the DU, or transmitted by the DU and the AAU. It can be considered that, the network device may include at least one of the CU, the DU, or the AAU. In addition, the CU may be categorized into a network device in a RAN, or may be categorized into a network device in a CN, which is not limited herein.

In some possible implementations, the network device may be any one of multiple stations that perform coherent joint transmission (CJT) with the terminal device, another station other than the multiple stations, or another network device that performs network communication with the terminal device, which is not limited herein. Multi-station coherent joint transmission may be joint coherent transmission of multiple stations, transmission of different data belonging to the same physical downlink shared channel (PDSCH) from different stations to the terminal device, or transmission by multiple stations virtualized into one station. Names with the same meaning specified in other standards are also applicable to the disclosure. That is, the names of these parameters are not limited in the disclosure. The station in multi-station coherent joint transmission may be a remote radio head (RRH), a transmission and reception point (TRP), a network device, etc., which is not limited herein.

In some possible implementations, the network device may be any one of multiple stations that perform incoherent joint transmission with the terminal device, another station other than the multiple stations, or another network device that performs network communication with the terminal device, which is not limited herein. Multi-station incoherent joint transmission may be joint incoherent transmission of multiple stations, transmission of different data belonging to the same PDSCH from different stations to the terminal device, or transmission of different data belonging to the same PDSCH from different stations to the terminal device. Names with the same meaning specified in other standards are also applicable to the disclosure. That is, the names of these parameters are not limited in the disclosure. The station in multi-station incoherent joint transmission may be a RRH, a TRP, a network device, etc., which is not limited herein.

In some possible implementations, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In some possible implementations, the network device may provide services for a cell. The terminal device in the cell can communicate with the network device through transmission resources, such as spectrum resources. The cell may be a macro cell, a small cell, a metro cell, a micro cell, a pico cell, a femto cell, etc.

### 4. Exemplary Description

The communication system in embodiments of the disclosure is exemplified below.

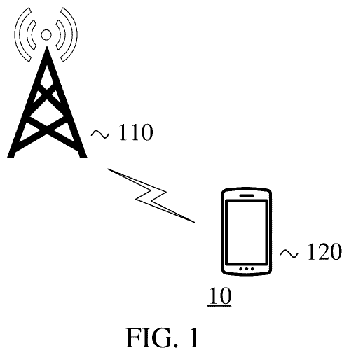

Exemplarily, referring to FIG. 1, a network architecture of a communication system in embodiments of the disclosure is illustrated. As illustrated in FIG. 1, a communication system 10 may include a network device 110 and a terminal device 120. The network device 110 and the terminal device 120 may communicate with each other wirelessly.

FIG. 1 only illustrates an example of the network architecture of the communication system, and does not constitute a limitation on the network architecture of the communication system in embodiments of the disclosure. For example, in embodiments of the disclosure, the communication system may further include a server or other devices. For another example, in embodiments of the disclosure, the communication system may include multiple network devices and/or multiple terminal devices.

### II. CSI Reporting Process

### 1. CSI Configuration

Relevant studies on CSI have been conducted in protocol standards developed by the 3rd generation partnership project (3GPP).

The CSI is used for the terminal device to feed back downlink channel quality to the network device, i.e., the terminal device can feed back downlink channel quality to the network device based on the CSI, so that the network device can select a suitable modulation and coding scheme (MCS) for downlink data transmission to reduce a block error rate (BLER) of downlink data transmission, and perform corresponding beam management, mobility management, adaptive tracking, rate matching, and other processing.

Relevant configuration information for CSI may be defined by a higher-layer parameter CSI-MeasConfig. CSI-MeasConfig may indicate (contain) two higher-layer parameters: CSI resource configuration information (CSI-ResourceConfig) and CSI report configuration information (CSI-ReportConfig).

In addition, since CSI-ReportConfig indicates (contains) CSI-ResourceConfigld, CSI-ResourceConfig is associated with (corresponds to/mapped to) CSI-ReportConfig through CSI-ResourceConfigId.

CSI-ReportConfig is used to configure CSI reporting, that is, configure CSI reports.

CSI-ResourceConfig is used to configure CSI-RS resources for CSI measurement. In addition, CSI-ResourceConfig can be used to configure resource sets (such as ResourceSet), and ResourceSet can contain the most basic CSI-RS resource (such as CSI-RS-Resource).

CSI-RS-Resource can indicate (contain) three types of resource sets: a NZP-CSI-RS resource set (NZP-CSI-RS-ResourceSet), a CSI interference measurement (CSI-IM) resource set (CSI-IM-ResourceSet), and a SSB resource set (CSI-SSB-ResourceSet).

NZP-CSI-RS-ResourceSet can be used for channel measurement and/or interference measurement. CSI-IM-ResourceSet can be used for interference measurement. CSI-SSB-ResourceSet can be used for channel measurement.

The type of CSI-RS resources can be periodic, semi-persistent, or aperiodic.

A report configuration type (reportConfigType) in CSI-ReportConfig can be used to indicate the report type of the CSI report. The CSI report can be transmitted on a physical uplink control channel (PUCCH) or a physical uplink shared channel (PUSCH).

In embodiments of the disclosure, CSI measurement can be understood as measuring a downlink channel through the CSI-RS resources configured by CSI-ResourceConfig.

### 2. CSI Report

### (1) Report Type of CSI Report

The report type of the CSI report may include: periodic CSI report, aperiodic CSI report, semi-persistent CSI report on PUCCH, and semi-persistent CSI report on PUSCH.

It should be noted that, since the PUCCH is used to report the periodic CSI, the periodic CSI report is carried on the PUCCH, and since the PUSCH is used to report the aperiodic CSI, the aperiodic CSI report is carried on the PUSCH.

For an aperiodic CSI report and a semi-persistent CSI report carried on a PUSCH, the network device may further configure a higher-layer parameter TriggerState and a higher-layer parameter reportTriggerSize that apply to a CSI request field in downlink control information (DCI).

Periodic CSI report: it will take effect immediately after a periodic CSI-RS resource and report parameter are configured by a radio resource control (RRC) message or RRC signaling, without activating or triggering CSI-RS transmission and CSI report by a media access control-control element (MAC-CE)/DCI.

Semi-persistent CSI report on PUCCH: if semi-persistent CSI-RS transmission is configured by an RRC message, it is necessary to firstly activate the CSI-RS transmission by MAC CE 1, and then activate CSI report by MAC CE 2. If periodic CSI-RS transmission is configured by an RRC message, it is only necessary to activate CSI report by MAC CE 2, and there is no need to activate the CSI-RS transmission by MAC CE 1.

Semi-persistent CSI report on PUSCH: if semi-persistent CSI-RS transmission is configured by an RRC message, it is necessary to firstly activate the CSI-RS transmission by MAC CE 1 and then trigger CSI report by DCI. If periodic CSI-RS transmission is configured by an RRC message, it is only necessary to trigger CSI report by DCI, and there is no need to activate the CSI-RS transmission by MAC CE 1.

It should be noted that, for the DCI, the DCI may be DCI format 0-1 scrambled by a semi-persistent CSI radio network temporary identifier (SP-CSI-RNTI), and a CSI request field in the DCI may be associated with a corresponding trigger state (TriggerState) by setting a codepoint. TriggerState may define associated CSI-ReportConfig, so that CSI-ReportConfig associated with a semi-persistent CSI report on a PUSCH can be found according to TriggerState.

Aperiodic CSI report: for a scenario of aperiodic CSI-RS transmission and aperiodic CSI report, both aperiodic CSI-RS transmission and aperiodic CSI report are triggered by DCI, and the procedure thereof is similar to that for the semi-persistent CSI report described above. When associating corresponding TriggerState with a codepoint of a CSI request field in DCI format 0_1/0_2, different from DCI triggering of semi-persistent CSI report, if the value of the CSI request field is “0”, it indicates that there is no need to trigger semi-periodic CSI report; and if the value of the CSI request field is “1”, it indicates that aperiodic CSI report associated with TriggerState1 is to be triggered, and so forth.

### (2) Combination of CSI Report Configuration and CSI-RS Resource Configuration

It should be noted that, the combination of CSI report configuration and CSI-RS resource configuration is illustrated in Table 1.

TABLE 1

| CSI-RS | periodic | | aperiodic |
|---|---|---|---|
| configuration | CSI report | semi-persistent CSI report | CSI report |
| periodic | non-dynamic | when carried on the PUCCH, | triggered |
| CSI-RS | triggering/ | activated by the terminal device | by DCI |
| | activation | upon receiving an activation | |
| | | command; when carried on the | |
| | | PUSCH, triggered by the terminal | |
| | | device upon receiving a DCI | |
| semi- | not supported | when carried on the PUCCH, | triggered |
| persistent | | activated by the terminal device | by DCI |
| CSI-RS | | upon receiving an activation | |
| | | command; when carried on the | |
| | | PUSCH, triggered by the terminal | |
| | | device upon receiving a DCI | |
| aperiodic | not supported | not supported | triggered |
| CSI-RS | | | by DCI |

### (3) Reporting Manner of CSI Report

The CSI report can be reported in a band (or referred to as wideband) or a subband. The band can be defined as the size of a configured bandwidth part (BWP), and the subband can be defined as N_{PRB}^{SB} continuous physical resource blocks (PRBs). A subband size depends on the total number of PRBs in the BWP. The correspondence between the total number of PRBs in the BWP and the subband size is illustrated in Table 2.

TABLE 2

| BWP (PRBs) | subband size (PRBs) |
|---|---|
| 24-72 | 4, 8 |
| 73-144 | 8, 16 |
| 145-275 | 16, 32 |

For the subband size, the terminal device can indicate one of two possible subband sizes via a higher-layer signaling, such as a parameter CSI reporting bandwidth (csi-ReportingBand) in CSI-ReportConfig. For example, in Table 2, if the total number of PRBs in the BWP is in the range of 24-72, the subband size is 4 or 8. Therefore, one subband size is determined from 4 or 8 according to csi-ReportingBand.

### (4) Type of CSI Parameter Contained in CSI Report

The CSI report may contain at least one of the following CSI parameters (also referred to as quantities): a layer 1 reference signal received power (L1-RSRP), a layer 1 signal-to-noise and interference ratio (L1-SINR), CSI-related quantities, etc.

Specifically, the CSI-related quantities may include at least one of: a CSI-RS resource indicator (CRI), a SS/PBCH block resource indicator (SSBRI), a rank indicator (RI), a precoding matrix indicator (PMI), a channel quality indicator (CQI), a layer indicator (LI), etc.

It should be noted that, the CRI (or SSBRI) can represent a CSI-RS (or SSB) resource recommended (or selected) by the terminal device, where one CSI-RS (or SSB) resource can represent one beam or antenna direction.

The RI can indicate the number of layers recommended (or selected) by the terminal device, and a codebook can be determined according to the number of layers. Each number of layers corresponds to one codebook, for example, a codebook with two layers or a codebook with one layer, where one codebook consists of one or more codewords. In addition, in MIMO technology, the number of layers can indicate the number of transmission links between the transmitter and the receiver.

The PMI can indicate an index of a codeword in a codebook recommended (or selected) by the terminal device, or quantized precoding information. One codeword corresponds to one precoding matrix. The RI and the PMI can together indicate the number of layers and a precoding matrix recommended by the terminal device.

The CQI can indicate the channel quality of a current channel fed back by the terminal device to the network device. The terminal device needs to calculate the CQI.

### 3. CSI Reporting Band

Report frequency configuration information (reportFreqConfiguration) in CSI-ReportConfig indicates a frequency granularity of CSI reporting.

A CSI reporting setting configuration can define the CSI reporting band as a subset of subbands in a BWP. That is, an active BWP can be divided into multiple subbands, and a subset (i.e., a part) of the multiple subbands can be defined as the CSI reporting band.

reportFreqConfiguration can indicate the following.

csi-ReportingBand is a continuous or non-continuous subset of subbands in a BWP, and a CSI should be reported.

Wideband CQI reporting or subband CQI reporting can be configured by a higher-layer parameter, such as a CQI format indicator cqi-FormatIndicator. For configuration of wideband CQI reporting, one wideband CQI is reported for each codeword for the entire CSI reporting band. For configuration of subband CQI reporting, one CQI for each codeword is reported for each subband in the CSI reporting band.

Wideband PMI reporting or subband PMI reporting can be configured by a higher-layer parameter, such as a PMI format indicator pmi-FormatIndicator. For configuration of wideband PMI reporting, one wideband PMI is reported for the entire CSI reporting band. For configuration of subband PMI reporting, except for two antenna ports, a single wideband indication is reported for the entire CSI reporting band, and one subband indication is reported for each subband in the CSI reporting band. When a subband PMI is configured with two antenna ports, one PMI is reported for each subband in the CSI reporting band.

### III. New Configuration Manner of Frequency Domain Resources

### 1. New Allocation Manner of Frequency Domain Resources

With the rapid growth of user demand for uplink services, higher requirements are placed on the uplink coverage, the rate, and the latency of the terminal device in the network.

In an existing time division duplexing (TDD) system, the transmission directions on the same time domain resource are the same. Usually, for the TDD system, the transmission direction is configured at the granularity of slots. In addition, an uplink/downlink slot ratio restriction is imposed on the TDD system, which leads to a large transmission delay in the TDD system. In order to reduce the implementation complexity of the network device, transmission directions of all frequency domain resources of one TDD carrier at the same moment need to be the same, that is, the uplink transmission direction or the downlink transmission direction. Therefore, uplink/downlink slot ratios of different frequency domain resources of one TDD carrier cannot be flexibly configured. With the diversification of services, especially considering the service requirements of vertical industries, different services have different uplink/downlink transmission requirements, and a single uplink/downlink slot ratio cannot meet the requirements of different services.

For example, the network configures slot 0 and slot 1 as the downlink transmission direction, and slot 2 as the uplink transmission direction. In this case, the network device can only perform downlink communication in slot 0 and slot 1, but not uplink communication. The network device can only perform uplink communication in slot 2, but not downlink communication. As a result, a terminal device with uplink service requirements cannot transmit uplink data to the network device in slot 0 and slot 1, and needs to wait until slot 2 to perform uplink communication, which results in a large transmission delay.

In an existing full duplex system, the network device and the terminal device can perform uplink communication and downlink communication simultaneously.

Different from the existing time division duplexing system and full duplex system, to consider the implementation complexity of the network device, in embodiments of the disclosure, a new allocation manner of frequency domain resources is considered. That is, different transmission directions are configured at the granularity of frequency domain resources in the same time unit, so that different transmission directions can be configured for different frequency domain resources in the same time unit.

That is, in the same time unit, there are both frequency domain resources supporting uplink transmission (uplink communication) (i.e., uplink frequency domain resources) and frequency domain resources supporting downlink transmission (downlink communication) (i.e., downlink frequency domain resources).

Therefore, in the new allocation manner of frequency domain resources, multiple frequency domain resources in the same time unit may include uplink frequency domain resources and downlink frequency domain resources. The uplink frequency domain resource in the multiple frequency domain resources may be continuous in the frequency domain, and the downlink frequency domain resource in the multiple frequency domain resources may be continuous in the frequency domain.

It should be noted that, when the time unit is one slot, different from the TDD system in which one slot can only support uplink transmission or downlink transmission, in the new allocation manner of frequency domain resources, one slot can support both uplink transmission and downlink transmission.

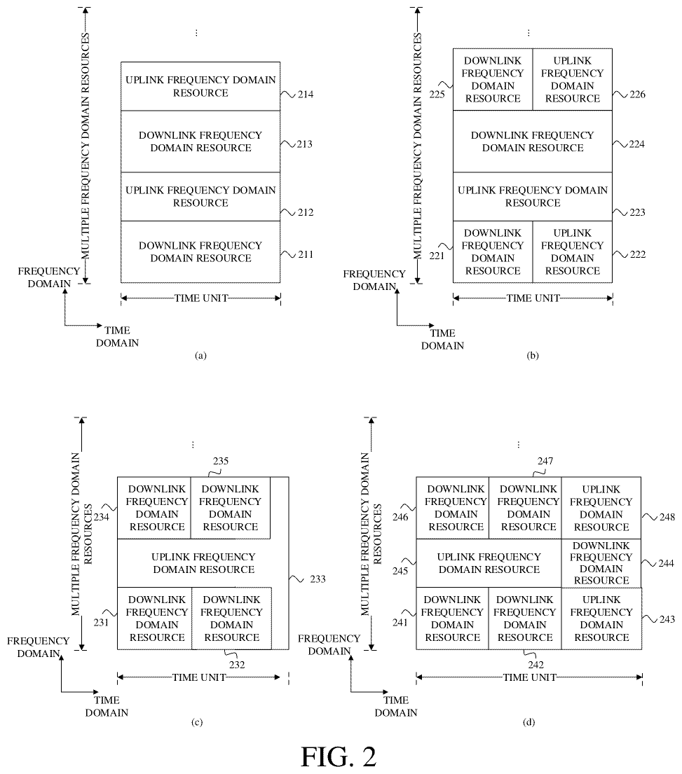

For example, as illustrated in FIG. 2, multiple frequency domain resources are configured in the same time unit, some frequency domain resources are uplink frequency domain resources, and other frequency domain resources are downlink frequency domain resources. The uplink frequency domain resource is continuous in the frequency domain, and the downlink frequency domain resource is continuous in the frequency domain. As illustrated in (a) of FIG. 2, the multiple frequency domain resources in the same time unit include a downlink frequency domain resource 211, an uplink frequency domain resource 212, a downlink frequency domain resource 213, and an uplink frequency domain resource 214. The downlink frequency domain resource 211 is continuous in the frequency domain, the uplink frequency domain resource 212 is continuous in the frequency domain, the downlink frequency domain resource 213 is continuous in the frequency domain, and the uplink frequency domain resource 214 is continuous in the frequency domain.

For another example, the network device configures both uplink frequency domain resources and downlink frequency domain resources in slot 1 and slot 2. In this way, compared with the existing time division duplexing system in which the terminal device needs to wait until slot 2 to perform uplink communication, in the new configuration manner of frequency domain resources, the terminal device can perform uplink communication in slot 1 without waiting until slot 2, thereby reducing the transmission delay.

In conclusion, configuring different transmission directions at the granularity of frequency domain resources in the same time unit in embodiments of the disclosure provides the following advantages.

The network device can perform uplink transmission or downlink transmission with different terminal devices, which is conducive to meeting communication requirements of different terminal devices. A terminal device with uplink service requirements can conduct uplink services faster by using the uplink frequency domain resource, thereby reducing the transmission delay and greatly improving the flexibility of the communication manner of the TDD communication system.

### 2. How to Determine Multiple Frequency Domain Resources in the Same Time Unit

In some possible implementations, in the disclosure, frequency domain start positions and sizes/lengths of frequency domain resources in the same time unit can be determined according to network configuration, pre-configuration, or a protocol specification. In this way, multiple frequency domain resources in the time unit can be determined according to the frequency domain start positions of the frequency domain resources and the sizes/lengths of the frequency domain resources.

For example, taking network configuration as an example, the network device transmits configuration information to the terminal device (the configuration information can be carried by a higher-layer parameter/higher-layer signaling/DCI/system information, etc.), and the configuration information can be used to configure the frequency domain start positions and the sizes of the frequency domain resources in the time unit.

### 3. Time Unit

In embodiments of the disclosure, the time unit can be understood as the communication granularity in the time domain. For example, the time unit can be a subframe, a slot, a symbol, or a mini slot, etc., which is not limited herein.

In addition, the time unit in the disclosure may be one of a subframe, a slot, a symbol, or a mini slot, which is not limited herein.

For example, in the disclosure, multiple frequency domain resources may be configured in one or more slots, multiple frequency domain resources may be configured in one or more symbols, or multiple frequency domain resources may be configured in one or more mini slots.

### 4. Frequency Domain Resource

In embodiments of the disclosure, frequency domain resources may support different transmission directions. That is, in the disclosure, a frequency domain resource may be configured to support uplink transmission, in which case the frequency domain resource is an uplink frequency domain resource, and a frequency domain resource may be configured to support downlink transmission, in which case the frequency domain resource is a downlink frequency domain resource.

In embodiments of the disclosure, the frequency domain resources may be subbands, continuous resource block (RB) sets, etc.

It should be noted that, the subband herein is different from the subband in “(3) Reporting manner of CSI report”. The subband herein can be understood as a subband divided from a bandwidth. The bandwidth can be a BWP. Each subband supports either only uplink transmission or only downlink transmission.

The continuous RB set herein can be understood as continuous multiple RBs. In addition, the RB in the disclosure can be a PRB, a virtual RB (VRB), etc.

In some possible implementations, the subband herein may be configured on a BWP or on a carrier.

When the frequency domain resource is a subband, multiple frequency domain resources in the time unit may be multiple subbands in the time unit. For example, subband non-overlapping full duplex (SBFD) is adopted.

### IV. A Communication Method

In combination with the above, it can be seen that when the new configuration manner of frequency domain resources is not considered on the basis of the active BWP, the active BWP is usually divided into multiple subbands, and a subset (i.e., a part) of the multiple subbands is defined as a CSI reporting band. That is, the CSI reporting band is determined according to the active BWP, so as to perform CSI measurement and/or CSI reporting according to the CSI reporting band.

However, when considering the new configuration manner of frequency domain resources on the basis of the active BWP, there may be frequency domain resources in the active BWP that overlap with the uplink frequency domain resource in the multiple frequency domain resources in the same time unit. Since CSI measurement and/or CSI reporting involves downlink frequency domain resources, these overlapping frequency domain resources may be unavailable (non-available) for CSI measurement and/or CSI reporting. That is, these overlapping frequency domain resources cannot be used for CSI measurement and/or CSI reporting. Based on this, the disclosure aims to solve the problem of how to perform CSI measurement and/or CSI reporting when considering the new configuration manner of frequency domain resources on the basis of the active BWP, so as to ensure CSI performance.

In order to perform CSI measurement and/or CSI reporting considering the new configuration manner of frequency domain resources on the basis of the active BWP, in the disclosure, the CSI reporting band can be determined according to the active BWP and the multiple frequency domain resources in the same time unit, and then CSI measurement and/or CSI reporting can be performed according to the CSI reporting band. Since the determination of the CSI reporting band comprehensively considers the active BWP and the multiple frequency domain resources in the same time unit, the determined CSI reporting band can be used for CSI measurement and/or CSI reporting, thereby ensuring CSI performance.

The technical solutions, beneficial effects, concepts, etc. involved in embodiments of the disclosure are explained below.

### 1. Unavailable Frequency Domain Resource, Available Frequency Domain Resource,

overlapping, and non-overlapping

### 1) Unavailable Frequency Domain Resource and Available Frequency Domain Resource

In the disclosure, there may be frequency domain resources in the active BWP that overlap with the uplink frequency domain resource in the multiple frequency domain resources, and these overlapping frequency domain resources may be unavailable for CSI measurement and/or CSI reporting. That is, these overlapping frequency domain resources cannot be used for CSI measurement and/or CSI reporting. Therefore, for case of description and distinction, in the disclosure, these overlapping frequency domain resources are referred to as “unavailable frequency domain resources”.

That is, the unavailable frequency domain resource may be a frequency domain resource in the active BWP that overlaps with the uplink frequency domain resource in the multiple frequency domain resources.

Similarly, there may be frequency domain resources in the active BWP that do not overlap (non-overlapping) with the uplink frequency domain resource in the multiple frequency domain resources, and these non-overlapping frequency domain resources may be available for CSI measurement and/or CSI reporting. That is, these non-overlapping frequency domain resources can be used for CSI measurement and/or CSI reporting. Therefore, for ease of description and distinction, in the disclosure, these non-overlapping frequency domain resources are referred to as “available frequency domain resources”.

That is, the available frequency domain resource may be a frequency domain resource in the active BWP that does not overlap with the uplink frequency domain resource in the multiple frequency domain resources.

It should be noted that, each unavailable frequency domain resource is continuous in the frequency domain, and there may be one available frequency domain resource between every two unavailable frequency domain resources.

Each available frequency domain resource is continuous in the frequency domain, and there may be one unavailable frequency domain resource between every two available frequency domain resources.

In addition, the active BWP in the disclosure may be an active downlink BWP.

### 2) Overlapping and Non-Overlapping

It should be noted that, in the disclosure, whether frequency domain resources overlap can be determined at the communication granularity in the frequency domain. The communication granularity can be RB, resource element (RE), RE group (REG), subcarrier, etc.

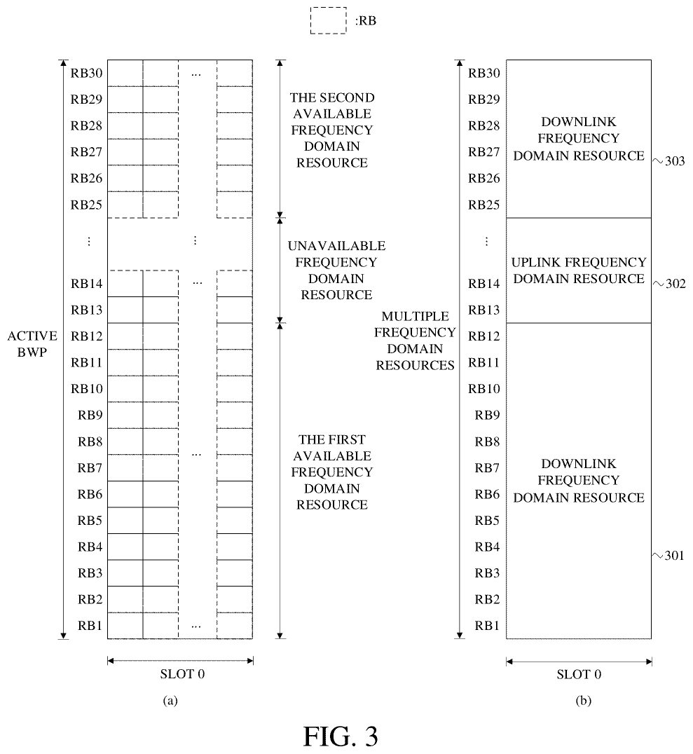

For example, whether frequency domain resources overlap is determined at the granularity of RBs, as illustrated in FIG. 3. In (a) of FIG. 3, the size of the active BWP in slot 0 is 30 RBs, the frequency domain start position of the active BWP is RB1, and the frequency domain end position of the active BWP is RB30.

In (b) of FIG. 3, multiple frequency domain resources in slot 0 also have the same frequency domain start position RB1 and the same frequency domain end position RB30. A downlink frequency domain resource 301 in the multiple frequency domain resources include 12 RBs from RB1 to RB12, an uplink frequency domain resource 302 in the multiple frequency domain resources include 12 RBs from RB13 to RB24, and a downlink frequency domain resource 303 in the multiple frequency domain resources include 6 RBs from RB25 to RB30.

Since the 12 RBs from RB13 to RB24 of the active BWP in (a) of FIG. 3 overlap with the uplink frequency domain resource 302 in (b) of FIG. 3, the 12 RBs from RB13 to RB24 are considered as an unavailable frequency domain resource in the active BWP, the 12 RBs from RB1 to RB12 are considered as an available frequency domain resource in the active BWP (for case of description and distinction, this available frequency domain resource is referred to as “the first available frequency domain resource” herein), and the 6 RBs from RB25 to RB30 are considered as another available frequency domain resource in the active BWP (for case of description and distinction, this available frequency domain resource is referred to as “the second available frequency domain resource” herein).

### 2. How to Determine the CSI Reporting Band

It should be noted that, in the disclosure, the CSI reporting band can be determined according to the active BWP and multiple frequency domain resources in the same time unit, so that the CSI reporting band is a part of frequency domain resources of the active BWP, and there may be an available subband and/or an unavailable subband in the CSI reporting band.

In specific implementation, in the disclosure, the unavailable frequency domain resource and/or the available frequency domain resource can be determined according to the active BWP and the multiple frequency domain resources, and then the CSI reporting band can be determined according to the unavailable frequency domain resource and/or the available frequency domain resource.

The disclosure will separately describe how to determine the CSI reporting band according to the unavailable frequency domain resource and/or the available frequency domain resource.

### Solution 1:

### 1) Description

In Solution 1, in the disclosure, the unavailable frequency domain resource in the active BWP can be excluded, so as to determine the CSI reporting band according to the available frequency domain resource.

In specific implementation, the available frequency domain resource is divided into subbands to determine the CSI reporting band.

It should be noted that, excluding the unavailable frequency domain resource can be understood as ignoring/eliminating the unavailable frequency domain resource. In this way, the CSI reporting band can be determined according to the available frequency domain resource.

For example, in combination with FIG. 3, in the disclosure, 12 RBs from RB13 to RB24 may be ignored, and 12 RBs from RB1 to RB12 and 6 RBs from RB25 to RB30 can be divided into subbands, so as to determine the CSI reporting band.

2) Characteristics of Subbands Divided from the Available Frequency Domain Resource

It should be noted that, in Solution 1, the available frequency domain resource is divided into subbands. In this way, all subbands divided from the available frequency domain resource are in the available frequency domain resource. In other words, all subbands divided from the available frequency domain resource belong to the available frequency domain resource.

For case of description and distinction, in the disclosure, all subbands in the available frequency domain resource are referred to as “available subbands”.

That is, all RBs in the available subband do not overlap with the uplink frequency domain resource in the multiple frequency domain resources. In other words, all RBs in the available subband are located in the available frequency domain resource.

In addition, in the disclosure, since a subband in the CSI reporting band is determined according to the subbands divided from the available frequency domain resource, the subband in the CSI reporting band may include the available subband.

3) how to Divide the Available Frequency Domain Resource into Subbands to Determine the Subband in the CSI Reporting Band

It should be noted that, in Solution 1, the available frequency domain resource is divided into subbands. In this way, all divided subbands are located in the available frequency domain resource, and then the CSI reporting band is determined according to the subbands divided from the available frequency domain resource, so that all subbands in the CSI reporting band are also located in the available frequency domain resource.

In the disclosure, subband division may be performed in the following manners to determine the subband in the CSI reporting band.

### Manner A:

In some possible implementations, the subband in the CSI reporting band can be determined by independently dividing each available frequency domain resource into subbands.

It can be understood that, in the disclosure, each available frequency domain resource in the active BWP can be independently divided into subbands, and the CSI reporting band can be determined according to the divided subbands. Since the divided subbands are available subbands, the subband in the CSI reporting band includes the available subband.

It should be noted that, with regard to how to independently divide each available frequency domain resource into subbands, in the disclosure, the size of a start subband (or referred to as a first subband) and the size of an end subband (or referred to as a last subband) can be determined according to network configuration, pre-configuration, or a standard protocol specification, and other subbands can be determined according to network configuration, pre-configuration, or a standard protocol specification, or the number of RBs remaining in each available frequency domain resource.

For example, the network configures the subband size

$${N}_{PRB}^{SB}$$

as 4, that is,

$${N}_{PRB}^{SB} = 4 ,$$

and the subband division is determined as follows.

The size of the start subband is

$${N}_{PRB}^{SB} - ( {N}_{BWP}^{start} mod {N}_{PRB}^{SB} ) , where {N}_{BWP}^{start}$$

represents a start RB of the active BWP and is configured by the network.

If

$$( {N}_{BWP}^{start} + {N}_{BWP}^{size} ) mod {N}_{PRB}^{SB} \neq 0 ,$$

the size of the end subband is

$$( {N}_{BWP}^{start} + {N}_{BWP}^{size} ) mod {N}_{PRB}^{SB} . If ( {N}_{BWP}^{start} + {N}_{BWP}^{size} ) mod {N}_{PRB}^{SB} = 0 ,$$

the size of the end subband is

$${N}_{PRB}^{SB} .$$

N_{BWP}^{size} represents the size of the active BWP and is configured by the network.

The sizes of other subbands can be

$${N}_{PRB}^{SB} = 4$$

or other values smaller than

$${N}_{PRB}^{SB} = 4 .$$

The other values can be determined according to the number of RBs remaining in each available frequency domain resource.

The subband division is explained below with reference to FIG. 3.

Example 1, in FIG. 3, the active BWP includes the first available frequency domain resource and the second available frequency domain resource. Since in Manner A, each available frequency domain resource is independently divided into subbands, it is necessary to separately divide the first available frequency domain resource and the second available frequency domain resource into subbands.

$${N}_{BWP}^{start} = 1. {N}_{BWP}^{size} = 30 .$$

The first available frequency domain resource is divided into subbands. The size of the start subband is

$${N}_{PRB}^{SB} - ( {N}_{BWP}^{start} mod {N}_{PRB}^{SB} ) = 4 - ( 1 mod 4 ) = 3 ,$$

the size of the second subband is

$${N}_{PRB}^{SB} = 4 ,$$

the size of the third subband is

$${N}_{PRB}^{SB} = 4 ,$$

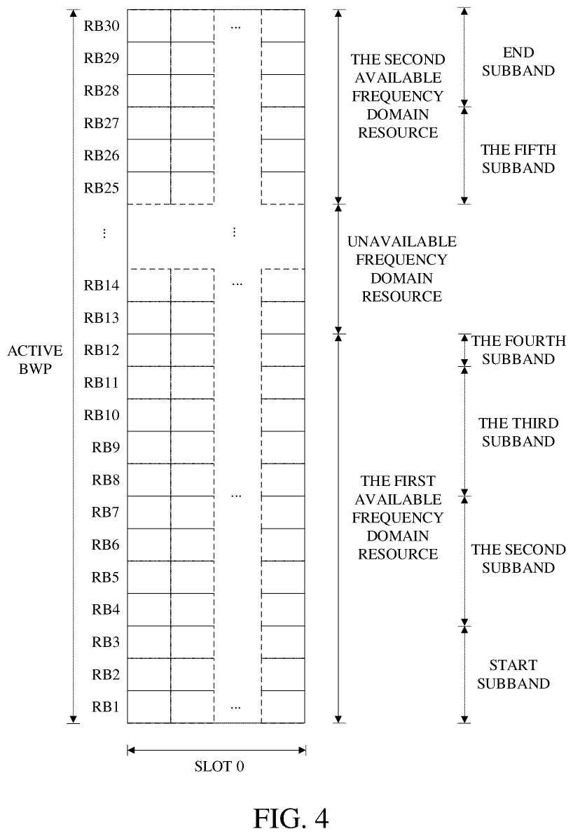

and the size of the fourth subband is 1 as there is only one RB left in the first available frequency domain resource, as illustrated in FIG. 4.

The second available frequency domain resource is divided into subbands. The size of the end subband is

$$( {N}_{BWP}^{start} + {N}_{BWP}^{size} ) mod {N}_{PRB}^{SB} = ( 1 + 30 ) mod 4 = 3 ,$$

and the size of the fifth subband is 3 as there are only three RBs left in the second available frequency domain resource except the end subband, as illustrated in FIG. 4.

In some possible implementations, the CSI reporting band can be determined according to the divided subbands as follows. At least one of the divided subbands is constructed as the CSI reporting band.

For example, in Example 1, at least one of the start subband, the second subband, the third subband, the fourth subband, the fifth subband, and the end subband is constructed as the CSI reporting band. That is, the subband in the CSI reporting band includes at least one of the start subband, the second subband, the third subband, the fourth subband, the fifth subband, and the end subband, and these subbands are all available subbands.

### Manner B:

In some possible implementations, the subband in the CSI reporting band can be determined by jointly dividing multiple available frequency domain resources into subbands.

It can be understood that, in the disclosure, multiple available frequency domain resources in the active BWP can be jointly divided into subbands, and the CSI reporting band can be determined according to the divided subbands. Since the divided subbands are available subband, the subband in the CSI reporting band includes the available subband.

It should be noted that, with regard to how to jointly divide multiple available frequency domain resources into subbands, in the disclosure, the size of the start subband and the size of the end subband can be determined according to network configuration, pre-configuration, or a standard protocol specification, etc., and other subbands can be determined according to network configuration, pre-configuration, or a standard protocol specification, or the number of RBs remaining in the combined multiple available frequency domain resources.

For example, the network configures the subband size

$${N}_{PRB}^{SB}$$

as 4, that is

$${N}_{PRB}^{SB} = 4 ,$$

and the subband division is determined as follows.

The size of the start subband is

$${N}_{PRB}^{SB} - ( {N}_{BWP}^{start} mod {N}_{PRB}^{SB} ) , where {N}_{BWP}^{start}$$

represents the start RB of the active BWP and is configured by the network.

If

$$( {N}_{BWP}^{start} + {N}_{BWP}^{size} ) mod {N}_{PRB}^{SB} \neq 0 ,$$

the size of the end subband is

$$( {N}_{BWP}^{start} + {N}_{BWP}^{size} ) mod {N}_{PRB}^{SB} . If ( ( {N}_{BWP}^{start} + {N}_{BWP}^{size} ) mod {N}_{PRB}^{SB} = 0 ,$$

the size of the end subband is

$${N}_{PRB}^{SB} .$$

$${N}_{BWP}^{size}$$

represents the size of active BWP and is configured by the network.

The sizes of other subbands can be

$${N}_{PRB}^{SB} = 4$$

or other values smaller than

$${N}_{PRB}^{SB} = 4.$$

The other values can be determined according to the number of RBs remaining in the combined multiple available frequency domain resources.

The subband division is explained below with reference to FIG. 3.

Example 2, in FIG. 3, the active BWP includes the first available frequency domain resource and the second available frequency domain resource. Since in Manner B, multiple available frequency domain resources are jointly divided into subbands, it is necessary to jointly divide the first available frequency domain resource and the second available frequency domain resource into subbands.

$${N}_{BWP}^{start} = 1.$$

$${N}_{BWP}^{size} = 30.$$

The first available frequency domain resource and the second available frequency domain resource are jointly divided into subbands. The size of the start subband is

$${N}_{PRB}^{SB} - ( {N}_{BWP}^{start} mod {N}_{PRB}^{SB} ) = 4 - ( 1 mod 4 ) = 3 ,$$

the size of the second subband is

$${N}_{PRB}^{SB} = 4 ,$$

the size of the third subband is

$${N}_{PRB}^{SB} = 4 ,$$

the size of the fourth subband is 4, where the fourth subband spans the first available frequency domain resource and the second available frequency domain resource, and the size of the end subband is

$$( {N}_{BWP}^{start} + {N}_{BWP}^{size} ) mod {N}_{PRB}^{SB} = ( 1 + 30 ) mod 4 = 3 ,$$

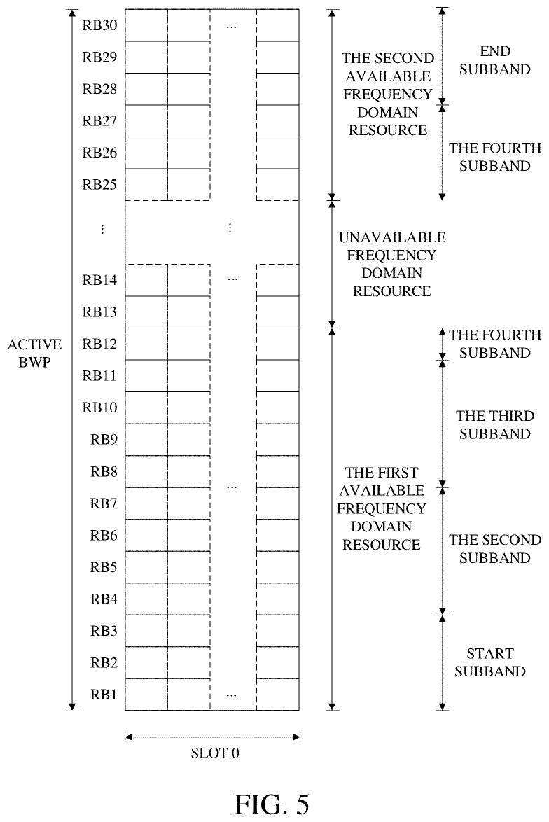

as illustrated in FIG. 5.

In some possible implementations, the CSI reporting band can be determined according to the divided subbands as follows. At least one of the divided subbands is constructed as the CSI reporting band.

For example, in Example 2, at least one of the start subband, the second subband, the third subband, the fourth subband, and the end subband is constructed as the CSI reporting band. That is, the subband in the CSI reporting band includes at least one of the start subband, the second subband, the third subband, the fourth subband, and the end subband, and these subbands are all available subbands.

### Solution 2:

### 1) Description

In Solution 2, in the disclosure, the unavailable frequency domain resource in the active BWP may not be excluded, so as to determine the CSI reporting band according to the unavailable frequency domain resource and the available frequency domain resource, or according to the active BWP.

In specific implementation, the unavailable frequency domain resource and the available frequency domain resource are divided into subbands to determine the CSI reporting band, or the active BWP is divided into subbands to determine the CSI reporting band.

For example, as illustrated in FIG. 3, in the disclosure, subband division may be performed on 30 RBs from RB1 to RB30 to determine the CSI reporting band.

2) How to divide the unavailable frequency domain resource and the available frequency domain resource into subbands (i.e., how to divide the active BWP into subbands)

It should be noted that, with regard to how to divide the unavailable frequency domain resource and the available frequency domain resource into subbands, in the disclosure, the size of a start subband (or referred to as a first subband), the size of an end subband (or referred to as a last subband), and the sizes of other subbands can be determined according to network configuration, pre-configuration, or a standard protocol specification.

For example, the network configures the subband size

$${N}_{PRB}^{SB}$$

as 4, that is

$${N}_{PRB}^{SB} = 4 ,$$

and the subband division is determined as follows.

The size of the start subband is

$${N}_{PRB}^{SB} - ( {N}_{BWP}^{start} mod {N}_{PRB}^{SB} ) , where {N}_{BWP}^{start}$$

represents a start RB of the active BWP and is configured by the network.

If

$$( {N}_{BWP}^{start} + {N}_{BWP}^{size} ) mod {N}_{PRB}^{SB} \neq 0 ,$$

the size of the end subband is

$$( {N}_{BWP}^{start} + {N}_{BWP}^{size} ) mod {N}_{PRB}^{SB} . If ( {N}_{BWP}^{start} + {N}_{BWP}^{size} ) mod {N}_{PRB}^{SB} = 0 ,$$

the size of the end subband is

$${N}_{PRB}^{SB} .$$

$${N}_{BWP}^{size}$$

represents the size of the active BWP and is configured by the network.

The sizes of other subbands can be

$${N}_{PRB}^{SB} = 4.$$

The subband division is explained below with reference to FIG. 3.

Example 3, in FIG. 3, the active BWP includes the first available frequency domain resource, the second available frequency domain resource, and the unavailable frequency domain resource.

$${N}_{BWP}^{start} = 1. {N}_{BWP}^{size} = 30.$$

The active BWP is divided into subbands. The size of the start subband is

$${N}_{PRB}^{SB} - ( {N}_{BWP}^{start} mod {N}_{PRB}^{SB} ) = 4 - ( 1 mod 4 ) = 3 ,$$

the size of the second subband is

$${N}_{PRB}^{SB} = 4 ,$$

the size of the third subband is

$${N}_{PRB}^{SB} = 4 ,$$

the size of the fourth subband is

$${N}_{PRB}^{SB} = 4 ,$$

the size of the fifth subband is

$${N}_{PRB}^{SB} = 4 ,$$

the size of the sixth subband

$${N}_{PRB}^{SB} = 4 ,$$

the size of the seventh subband is

$${N}_{PRB}^{SB} = 4 ,$$

and the size of the end subband is

$$( {N}_{BWP}^{start} + {N}_{BWP}^{size} ) mod {N}_{PRB}^{SB} = ( 1 + 30 ) mod 4 = 3 ,$$

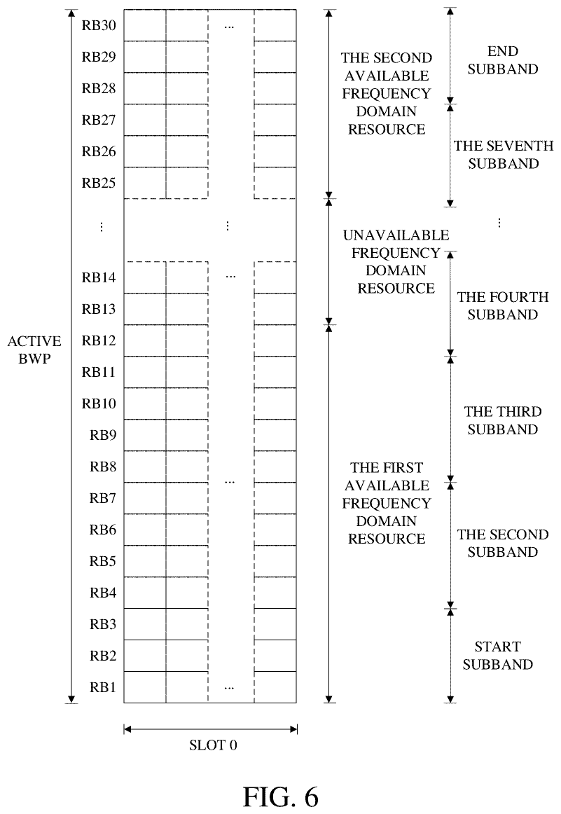

as illustrated in FIG. 6.
3) Characteristics of Subbands Divided from the Unavailable Frequency Domain Resource and the Available Frequency Domain Resource (i.e., Characteristics of Subbands Divided from the Active BWP)

It should be noted that, in Solution 2, the unavailable frequency domain resource and the available frequency domain resource are divided into subbands, that is, the active BWP is divided into subbands. In this way, among the subbands divided from the active BWP, some subbands may be completely or partially located in the available frequency domain resource, while some subbands may be completely or partially located in the unavailable frequency domain resource.

First. Available Subband

For ease of description and distinction, in the disclosure, a subband that is completely or partially located in the available frequency domain resource may be referred to as an “available subband”.

A subband partially located in the available frequency domain resource can be understood as a subband in which some RBs are located in the available frequency domain resource, while other RBs are located in the unavailable frequency domain resource. In this case, the subband can be an “available subband”. That is, some RBs in the available subband do not overlap with the uplink frequency domain resource in the multiple frequency domain resources.

For example, in Example 3, RB12 in the fourth subband is located in the available frequency domain resource, while other RBs in the fourth subband are located in the unavailable frequency domain resource. Therefore, the fourth subband can be an “available subband”.

A subband completely located in the available frequency domain resource can be understood as a subband in which all RBs are located in the available frequency domain resource. In this case, the subband can be an “available subband”. That is, all RBs in the available subband do not overlap with the uplink frequency domain resource in the multiple frequency domain resources.

For example, in Example 3, all RBs in the second subband are located in the available frequency domain resource. Therefore, the second subband may be an “available subband”.

Second. Unavailable Subband

For case of description and distinction, in the disclosure, a subband that is partially or completely located in the unavailable frequency domain resource may be referred to as an “unavailable subband”. Alternatively, an unavailable subband may be a subband other than the available subband in the CSI reporting band.

A subband partially located in the unavailable frequency domain resource can be understood as a subband in which some RBs are located in the available frequency domain resource, while other RBs are located in the unavailable frequency domain resource. In this case, the subband can be an “unavailable subband”. That is, some RBs in the unavailable subband overlap with the uplink frequency domain resource in the multiple frequency domain resources.

For example, in Example 3, RB24 in the seventh subband is located in the unavailable frequency domain resource, while other RBs in the seventh subband are located in the available frequency domain resource. Therefore, the seventh subband can be an “unavailable subband”.

A subband completely located in the unavailable frequency domain resource can be understood as a subband in which all RBs are located in the unavailable frequency domain resources. In this case, the subband can be an “unavailable subband”. That is, all RBs in the available subband overlap with the uplink frequency domain resource in the multiple frequency domain resources.

For example, in Example 3, all RBs in the fifth subband are located in the unavailable frequency domain resource. Therefore, the fifth subband may be an “unavailable subband”.

In conclusion, in Example 3, there may be the following combinations of available subbands and unavailable subbands.

### Combination 1:

Available subbands: the start subband, the second subband, the third subband, and the end subband. Unavailable subbands: the fourth subband, the fifth subband, the sixth subband, and the seventh subband.

### Combination 2:

Available subbands: the start subband, the second subband, the third subband, the fourth subband, the seventh subband, and the end subband. Unavailable subbands: the fifth subband and the sixth subband.

### 4) how to Determine the Subband in the CSI Reporting Band According to the Unavailable Frequency Domain Resource and the Available Frequency Domain Resource (i.e., how to Determine the Subband in the CSI Reporting Band According to the Active BWP)

It should be noted that, in the disclosure, the CSI reporting band can be determined according to subbands divided from the unavailable frequency domain resource and the available frequency domain resource (the active BWP), so that the subband in the CSI reporting band may be located in the available frequency domain resource and/or the unavailable frequency domain resource. The CSI reporting band can be determined in the following manner.

### Manner 1:

In some possible implementations, the CSI reporting band can be determined according to the unavailable frequency domain resource and the available frequency domain resource (the active BWP) as follows. At least one of available subbands in the subbands divided from the unavailable frequency domain resource and the available frequency domain resource (the active BWP) is constructed as the CSI reporting band.

As can be seen, the CSI reporting band may include the available subband.

For example, in Example 3, the subbands divided from the active BWP may be as follows.

Available subbands: the start subband, the second subband, the third subband, and the end subband. Unavailable subbands: the fourth subband, the fifth subband, the sixth subband, and the seventh subband.

Therefore, at least one of the available subbands is constructed as the CSI reporting band. That is, the subband in the CSI reporting band includes at least one of the start subband, the second subband, the third subband, and the end subband.

### Manner 2:

In some possible implementations, the CSI reporting band can be determined according to the unavailable frequency domain resource and the available frequency domain resource (the active BWP) as follows. At least one of the subbands divided from the unavailable frequency domain resource and the available frequency domain resource (the active BWP) is constructed as the CSI reporting band.

As can be seen, the CSI reporting band may include the available subband and/or the unavailable subband.

Of course, in order to ensure that the CSI reporting band can be used for CSI measurement and/or CSI reporting, the subband in the CSI reporting band needs to include the available subband. Therefore, the CSI reporting band includes the available subband, or the CSI reporting band may include the available subband and the unavailable subband.

For example, in Example 3, the subbands divided from the active BWP may be as follows.

Available subbands: the start subband, the second subband, the third subband, and the end subband. Unavailable subbands: the fourth subband, the fifth subband, the sixth subband, and the seventh subband.

Therefore, at least one of the subbands divided from the active BWP is constructed as the CSI reporting band. That is, the subband in the CSI reporting band includes at least one of the start subband, the second subband, the third subband, the fourth subband, the fifth subband, the sixth subband, the seventh subband, and the end subband.

### 3. How to Perform CSI Measurement According to the CSI Reporting Band

In combination with the above, it can be seen that the subband in the CSI reporting band may include the available subband, or may include the available subband and the unavailable subband. In addition, the subband in the CSI reporting band may be associated with at least one CSI-RS resource, and the at least one CSI-RS resource is in at least one ResourceSet.

That is, CSI-RS resources associated with the subbands in the CSI reporting band may be in the same ResourceSet or in different ResourceSets, which is not limited herein.

In this way, in the disclosure, CSI measurement can be performed on the downlink channel according to the CSI-RS resources associated with the subbands in the CSI reporting band, thereby realizing CSI measurement according to the CSI reporting band.

In addition, since each subband in the CSI reporting band is associated with a CSI-RS resource, CSI measurement is performed on the downlink channel according to the CSI-RS resource associated with each subband, so as to obtain a CSI parameter of each subband.

The CSI parameter may include at least one of: a L1-RSRP, a L1-SINR, CSI-related quantities, etc. The CSI-related quantities may include at least one of: a CRI, a SSBRI, a RI, a PMI, a CQI, a LI, etc.

In some possible implementations, the CSI-RS resources in the same ResourceSet have different start positions and/or different lengths.

It can be understood that, the CSI-RS resources associated with the subbands in the CSI reporting band may be in the same ResourceSet, and these CSI-RS resources in the same ResourceSet have different start positions and different lengths, so that CSI measurement of the downlink channel can be performed according to these CSI-RS resources.

Optionally, the start position may be a start RB, and the length may be the number of RBs. That is, the CSI-RS resources in the same ResourceSet have different start RBs and/or different numbers of RBs.

### 4. How to Perform CSI Reporting According to the CSI Reporting Band

### 1) Reporting of the CSI Report

In combination with the above, it can be seen that the subband in the CSI reporting band may include the available subband, or may include the available subband and the unavailable subband. In the disclosure, the CSI report may be reported according to the subband in the CSI reporting band as follows.

In some possible implementations, if the subband in the CSI reporting band includes the available subband, the available subband may be used to report the CSI report. The reported CSI report may include the CSI parameter of the available subband.

In some possible implementations, if the subband in the CSI reporting band includes the available subband and the unavailable subband, the available subband may be used to report the CSI report, while the unavailable subband is not used to report the CSI report. The reported CSI report may include the CSI parameter of the available subband.

In some possible implementations, if the subband in the CSI reporting band includes the available subband and the unavailable subband, both the available subband and the unavailable subband in the CSI reporting band can be used to report the CSI report. Since the unavailable subband cannot be used for CSI measurement, there is no CSI parameter for the unavailable subband. In this case, the CSI report reported in the unavailable subband needs to be filled with fixed information. The fixed information can be determined according to network configuration, pre-configuration, or a standard protocol definition. Finally, the reported CSI report can contain the CSI parameter of the available subband and the fixed information.

### 2) Reporting Manner of the CSI Report

It should be noted that, in the disclosure, the reporting manner of the CSI report can be configured by a higher-layer parameter/higher-layer signaling. The reporting manner of the CSI report can be as follows.

The CSI report is reported in a wideband, i.e., wideband CSI reporting

It should be noted that, for configuration of wideband CSI reporting, CSI parameters or fixed information of subbands in the CSI reporting band are combined to be reported in the same CSI report. That is, a combination of the CSI parameters and/or the fixed information is reported for the subbands in the CSI reporting band.

For example, if the subband in the CSI reporting band includes available subbands, CSI parameters of the available subbands are combined to be reported in the same CSI report.

If the subband in the CSI reporting band includes available subbands and unavailable subbands, CSI parameters of the available subbands and fixed information of the unavailable subbands are combined to be reported in the same CSI report.

In addition, since the subband in the CSI reporting band is associated with at least one CSI-RS resource, if CSI-RS resources associated with subbands in the CSI reporting band are in the same ResourceSet, the same ResourceSet corresponds to the same CSI report, and the same CSI report contains the CSI parameters or the fixed information of the subbands in the CSI reporting band.

If the CSI-RS resources associated with the subbands in the CSI reporting band are in different ResourceSets, different ResourceSets correspond to different CSI reports. Each CSI report contains CSI parameters or fixed information of subbands associated with the corresponding ResourceSet.

The CSI report is reported in a subband, i.e., subband CSI reporting

It should be noted that, for configuration of subband CSI reporting, CSI parameters or fixed information of subbands in the CSI reporting band are reported separately in CSI reports. That is, one CSI parameter is reported for each subband in the CSI reporting band.

For example, if the subband in the CSI reporting band includes available subbands, CSI parameters of the available subbands are reported separately in CSI reports.

If the subband in the CSI reporting band includes available subbands and unavailable subbands, CSI parameters of the available subbands are reported separately in CSI reports, and fixed information of the unavailable subbands is reported separately in CSI reports.

### 5. Exemplary Description of a Communication Method

In combination with the above content, an example of a communication method in embodiments of the disclosure is introduced below by taking interaction between a network device and a terminal device as an example. It should be noted that, the network device can be a chip, a chip module, or a communication module, etc., and the terminal device can be a chip, a chip module, or a communication module, etc. In other words, the method is applied to the network device or the terminal device, which is not limited herein.

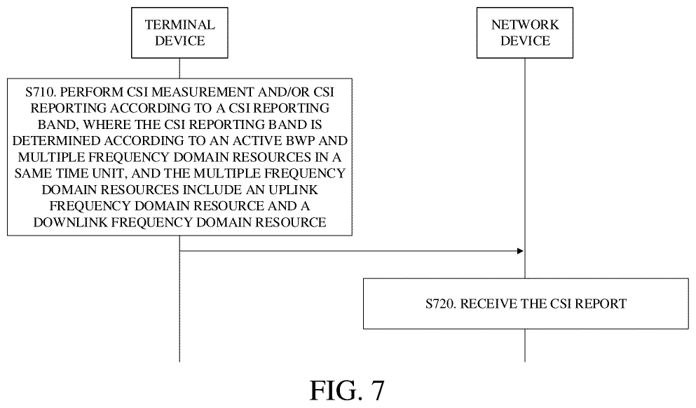

FIG. 7 is a flowchart of a communication method according to embodiments of the disclosure. The communication method specifically includes the following.

S710. A terminal device performs CSI measurement and/or CSI reporting according to a CSI reporting band, where the CSI reporting band is determined according to an active BWP and multiple frequency domain resources in a same time unit, and the multiple frequency domain resources include an uplink frequency domain resource and a downlink frequency domain resource.

The uplink frequency domain resource in the multiple frequency domain resources is continuous in the frequency domain, and the downlink frequency domain resource in the multiple frequency domain resources is continuous in the frequency domain.

S720: A network device receives the CSI report.

It should be noted that, for details of “CSI reporting band”, “CSI measurement”, “CSI report”, “multiple frequency domain resources in the same time unit”, etc., reference can be made to the above, which will not be repeated herein.

As can be seen, in embodiments of the disclosure, the multiple frequency domain resources in the same time unit are considered on the basis of the active BWP, since there may be frequency domain resources in the active BWP that overlap with the uplink frequency domain resource in the multiple frequency domain resources in the same time unit. Since CSI measurement and/or CSI reporting involves downlink frequency domain resources, these overlapping frequency domain resources may be unavailable for CSI measurement and/or CSI reporting. That is, these overlapping frequency domain resources cannot be used for CSI measurement and/or CSI reporting.

In order to perform CSI measurement and/or CSI reporting considering the multiple frequency domain resources in the same time unit on the basis of the active BWP, in the disclosure, the CSI reporting band can be determined according to the active BWP and the multiple frequency domain resources in the same time unit, and then CSI measurement and/or CSI reporting can be performed according to the CSI reporting band. Since the determination of the CSI reporting band comprehensively considers the active BWP and the multiple frequency domain resources in the same time unit, the determined CSI reporting band can be used for CSI measurement and/or CSI reporting, thereby ensuring CSI performance.

In some possible implementations, the CSI reporting band may be determined according to the active BWP and the multiple frequency domain resources in the same time unit as follows. The CSI reporting band is determined according to an unavailable frequency domain resource and/or an available frequency domain resource. The unavailable frequency domain resource is a frequency domain resource in the active BWP that overlaps with the uplink frequency domain resource in the multiple frequency domain resources. The available frequency domain resource is a frequency domain resource in the active BWP that does not overlap with the uplink frequency domain resource in the multiple frequency domain resources.

It should be noted that, in combination with “2. How to determine the CSI reporting band” above, in the disclosure, the unavailable frequency domain resource and/or the available frequency domain resource can be determined according to the active BWP and the multiple frequency domain resources, and then the CSI reporting band can be determined according to the unavailable frequency domain resource and/or the available frequency domain resource. Since the CSI reporting band can be determined according to the available frequency domain resource, the CSI reporting band can be in the available frequency domain resource, which facilitates CSI measurement and/or CSI reporting according to the CSI reporting band.

In some possible implementations, the CSI reporting band may be determined according to the unavailable frequency domain resource and/or the available frequency domain resource as follows. The unavailable frequency domain resource in the active BWP is excluded and the CSI reporting band is determined according to the available frequency domain resource.

It should be noted that, in combination with Solution 1, in the disclosure, the unavailable frequency domain resource in the active BWP can be excluded. In this way, the CSI reporting band can be determined according to the available frequency domain resource, so that the CSI reporting band can be in the available frequency domain resource, which facilitates CSI measurement and/or CSI reporting according to the CSI reporting band.

In some possible implementations, a subband in the CSI reporting band is determined according to the available frequency domain resource, the subband in the CSI reporting band includes an available subband, and all RBs in the available subband do not overlap with the uplink frequency domain resource in the multiple frequency domain resources.

It should be noted that, in combination with Solution 1, in Solution 1, the available frequency domain resource is divided into subbands. In this way, all subbands divided from the available frequency domain resource are in the available frequency domain resource. In addition, in the disclosure, since the subband in the CSI reporting band is determined according to the subbands divided from the available frequency domain resource, the subband in the CSI reporting band may include the available subband.

In some possible implementations, the subband in the CSI reporting band is determined according to the available frequency domain resource as follows. The subband in the CSI reporting band is determined by independently dividing each available frequency domain resource into subbands, or the subband in the CSI reporting band is determined by jointly dividing multiple available frequency domain resources into subbands.

It should be noted that, in combination with Manner A and Manner B, in the disclosure, each available frequency domain resource can be independently divided into subbands to determine the subband in the CSI reporting band, or multiple available frequency domain resources can be jointly divided into subbands to determine the subband in the CSI reporting band, so as to determine the subband in the CSI reporting band through subband division in various manners.

In some possible implementations, the CSI reporting band is determined according to the unavailable frequency domain resource and/or the available frequency domain resource as follows. The CSI reporting band is determined according to the unavailable frequency domain resource and the available frequency domain resource without excluding the unavailable frequency domain resource in the active BWP.

It should be noted that, in combination with Solution 2, in the disclosure, the unavailable frequency domain resource in the active BWP may not be excluded. In this way, the CSI reporting band can be determined according to the unavailable frequency domain resource and the available frequency domain resource, so that the CSI reporting band can be in the available frequency domain resource, which facilitates CSI measurement and/or CSI reporting according to the CSI reporting band.

In some possible implementations, a subband in the CSI reporting band is determined according to the unavailable frequency domain resource and the available frequency domain resource, the subband in the CSI reporting band includes an available subband, and some RBs in the available subband do not overlap with the uplink frequency domain resource in the multiple frequency domain resources, and/or all RBs in the available subband do not overlap with the uplink frequency domain resource in the multiple frequency domain resources.

It should be noted that, in combination with Solution 2, in Solution 2, the unavailable frequency domain resource and the available frequency domain resource are divided into subbands, that is, the active BWP is divided into subbands. In this way, among the subbands divided from the active BWP, some subbands may be completely or partially located in the available frequency domain resource. In addition, in the disclosure, since the subband in the CSI reporting band is determined according to the subbands divided from the active BWP, the subband in the CSI reporting band may include the available subband, and the available subband is completely or partially located in the available frequency domain resource.

In some possible implementations, a subband in the CSI reporting band is determined according to the unavailable frequency domain resource and the available frequency domain resource, the subband in the CSI reporting band includes an available subband and an unavailable subband, some RBs in the available subband do not overlap with the uplink frequency domain resource in the multiple frequency domain resources, and/or all RBs in the available subband do not overlap with the uplink frequency domain resource in the multiple frequency domain resources, and the unavailable subband is a subband other than the available subband in the CSI reporting band.

It should be noted that, in combination with Solution 2, in Solution 2, the unavailable frequency domain resource and the available frequency domain resource are divided into subbands, that is, the active BWP is divided into subbands. In this way, among the subbands divided from the active BWP, some subbands may be completely or partially located in the available frequency domain resource, while some subbands may be completely or partially located in the unavailable frequency domain resource. In addition, in the disclosure, since the subband in the CSI reporting band is determined according to the subbands divided from the active BWP, the subband in the CSI reporting band may include the available subband and the unavailable subband, the available subband is completely or partially located in the available frequency domain resource, and the unavailable subband is partially or completely located in the unavailable frequency domain resource.

In some possible implementations, the available subband in the CSI reporting band is used to report a CSI report.

It should be noted that, in combination with “4. How to perform CSI reporting according to the CSI reporting band” above, in the disclosure, since the subband in the CSI reporting band may include the available subband, or both the available subband and the unavailable subband, the CSI report can be reported in the available subband, while the unavailable subband is not used to report the CSI report.

In some possible implementations, the available subband and the unavailable subband in the CSI reporting band are both used to report a CSI report, and the CSI report reported in the unavailable subband is filled with fixed information.

It should be noted that, in combination with “4. How to perform CSI reporting according to the CSI reporting band” above, in the disclosure, since the subband in the CSI reporting band may include the available subband and the unavailable subband, the CSI report can be reported in the available subband and the unavailable subband, and the CSI report reported in the unavailable subband needs to be filled with the fixed information.

In some possible implementations, a subband in the CSI reporting band is associated with at least one channel state information reference signal (CSI-RS) resource, and the at least one CSI-RS resource is in at least one resource set.

It should be noted that, in combination with “3. How to perform CSI measurement according to the CSI reporting band” above, in the disclosure, CSI measurement can be performed on the downlink channel according to the CSI-RS resource associated with the subband in the CSI reporting band, thereby realizing CSI measurement according to the CSI reporting band.

In some possible implementations, if CSI-RS resources associated with subbands in the CSI reporting band are in a same resource set, the same resource set corresponds to a same CSI report, and the same CSI report contains CSI parameters or fixed information of the subbands in the CSI reporting band.

It should be noted that, in combination with “4. How to perform CSI reporting according to the CSI reporting band” above, in the disclosure, the CSI-RS resources associated with the subbands in the CSI reporting band can be in the same resource set, and the same resource set corresponds to the same CSI report, thereby realizing wideband CSI reporting.

In some possible implementations, the CSI-RS resources in the same resource set have different start positions and/or different lengths.

It should be noted that, in combination with “3. How to perform CSI measurement according to the CSI reporting band” above, the CSI-RS resources associated with the subbands in the CSI reporting band can be in the same ResourceSet, and these CSI-RS resources in the same ResourceSet have different start positions and different lengths, so that CSI measurement of the downlink channel can be performed according to these CSI-RS resources.

### V. Exemplary Description of a Communication Apparatus

The solutions in embodiments of the disclosure are introduced mainly from the perspective of the method. It can be considered that, in order to realize the foregoing functions, the terminal device or the network device includes corresponding hardware structures and/or software modules for executing respective functions. Those of ordinary skill in the art will appreciate that units and algorithmic operations of various examples described in connection with embodiments herein may be implemented by hardware or by a combination of hardware and computer software. Whether these functions are performed by means of hardware or hardware driven by computer software depends on the application and the design constraints of the associated technical solution. Those skilled in the art may use different methods with regard to each particular application to implement the described functionality, but such methods may not be regarded as lying beyond the scope of the disclosure.

In embodiments of the disclosure, division of functional units of the terminal device or the network device may be implemented according to the foregoing method examples. For example, functional units may be divided to correspond to respective functions, or two or more functions may be integrated into one processing unit. The integrated unit may be implemented in a form of hardware, or may be implemented in a form of software program module. It may be noted that, the division of units in embodiments of the disclosure is illustrative and is only a division of logical functions, and other methods of division may also available in practice.

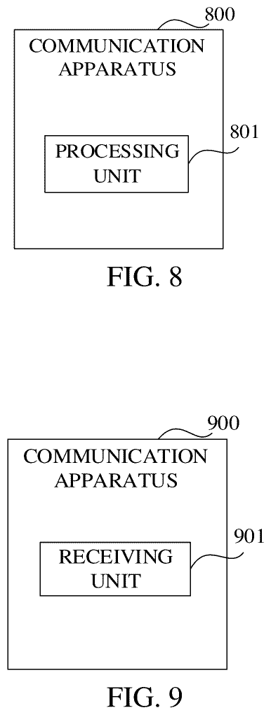

If an integrated unit is adopted, FIG. 8 is a block diagram of functional units of a communication apparatus according to embodiments of the disclosure. The communication apparatus 800 includes a processing unit 801.

In some possible implementations, the processing unit 801 may be a module or unit configured to process signals, data, information, etc., which is not limited herein.

In some possible implementations, the communication apparatus 800 may further include a storage unit configured to store computer program codes or instructions executed by the communication apparatus 800. The storage unit may be a memory.

In some possible implementations, the communication apparatus 800 may be a chip or a chip module.

In some possible implementations, the processing unit 801 may be integrated into other units.

For example, the processing unit 801 may be integrated in a communication unit. It should be noted that, the communication unit may be a communication interface, a transceiver, a transceiver circuit, or the like.

In some possible implementations, the processing unit 801 may be a processor or a controller, such as a baseband processor, a baseband chip, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various exemplary logic blocks, modules, and circuits disclosed in the disclosure may be implemented or executed. The processing unit may also be a combination for implementing computing functions, for example, one or more microprocessors, a combination of DSP and microprocessor, or the like.

In some possible implementations, the processing unit 801 is configured to perform any operation performed by the terminal device/chip/chip module, etc. in above method embodiments, such as transmitting or receiving data, etc., which is described in detail below.

In specific implementation, the processing unit 801 is configured to perform any operation in above method embodiments, and when executing actions such as transmitting, other units can be selectively invoked to complete corresponding operations.

The processing unit 801 is configured to perform CSI measurement and/or CSI reporting according to a CSI reporting band, where the CSI reporting band is determined according to an active BWP and multiple frequency domain resources in a same time unit, and the multiple frequency domain resources include an uplink frequency domain resource and a downlink frequency domain resource.

As can be seen, in embodiments of the disclosure, the multiple frequency domain resources in the same time unit are considered on the basis of the active BWP, since there may be frequency domain resources in the active BWP that overlap with the uplink frequency domain resource in the multiple frequency domain resources in the same time unit. Since CSI measurement and/or CSI reporting involves downlink frequency domain resources, these overlapping frequency domain resources may be unavailable for CSI measurement and/or CSI reporting. That is, these overlapping frequency domain resources cannot be used for CSI measurement and/or CSI reporting.

In order to perform CSI measurement and/or CSI reporting considering the multiple frequency domain resources in the same time unit on the basis of the active BWP, in the disclosure, the CSI reporting band can be determined according to the active BWP and the multiple frequency domain resources in the same time unit, and then CSI measurement and/or CSI reporting can be performed according to the CSI reporting band. Since the determination of the CSI reporting band comprehensively considers the active BWP and the multiple frequency domain resources in the same time unit, the determined CSI reporting band can be used for CSI measurement and/or CSI reporting, thereby ensuring CSI performance.

It should be noted that, for the implementation of various operations in the embodiments illustrated in FIG. 8, reference can be made to the elaborations in the method embodiments above, which will not be repeated herein.

### VI. Exemplary Description of Another Communication Apparatus

If an integrated unit is adopted, FIG. 9 is a block diagram of functional units of another communication apparatus according to embodiments of the disclosure. The communication apparatus 900 includes a receiving unit 901.

In some possible implementations, the receiving unit 901 may be a module or unit configured to process signals, data, information, etc., which is not limited herein.

In some possible implementations, the communication apparatus 900 may further include a storage unit configured to store computer program codes or instructions executed by the communication apparatus 900. The storage unit may be a memory.

In some possible implementations, the communication apparatus 900 may be a chip or a chip module.

In some possible implementations, the receiving unit 901 may be integrated into other units.

For example, the receiving unit 901 may be integrated in a communication unit. The communication unit may be a communication interface, a transceiver, a transceiver circuit, or the like.

For another example, the receiving unit 901 may be integrated in a processing unit. The processing unit can be a processor or a controller, such as a baseband processor, a baseband chip, a CPU, a DSP, an ASIC, an FPGA, or other programmable logic devices, transistor logic devices, hardware components, or any combination thereof. Various exemplary logic blocks, modules, and circuits disclosed in the disclosure may be implemented or executed. The processing unit may also be a combination for implementing computing functions, for example, one or more microprocessors, a combination of DSP and microprocessor, or the like.

In some possible implementations, the receiving unit 901 is configured to perform any operation performed by the network device/chip/chip module, etc. in above method embodiments, such as data transmission, for example, transmitting and receiving, which is described in detail below.

In specific implementation, the receiving unit 901 is configured to perform any operation in above method embodiments, and when executing actions such as receiving, other units can be selectively invoked to complete corresponding operations.

The receiving unit 901 is configured to receive a CSI report, where the CSI report is performed according to a CSI reporting band, the CSI reporting band is determined according to an active BWP and multiple frequency domain resources in a same time unit, and the multiple frequency domain resources include an uplink frequency domain resource and a downlink frequency domain resource.

As can be seen, in embodiments of the disclosure, the multiple frequency domain resources in the same time unit are considered on the basis of the active BWP, since there may be frequency domain resources in the active BWP that overlap with the uplink frequency domain resource in the multiple frequency domain resources in the same time unit. Since CSI measurement and/or CSI reporting involves downlink frequency domain resources, these overlapping frequency domain resources may be unavailable for CSI measurement and/or CSI reporting. That is, these overlapping frequency domain resources cannot be used for CSI measurement and/or CSI reporting.

In order to perform CSI measurement and/or CSI reporting considering the multiple frequency domain resources in the same time unit on the basis of the active BWP, in the disclosure, the CSI reporting band can be determined according to the active BWP and the multiple frequency domain resources in the same time unit, and then CSI measurement and/or CSI reporting can be performed according to the CSI reporting band. Since the determination of the CSI reporting band comprehensively considers the active BWP and the multiple frequency domain resources in the same time unit, the determined CSI reporting band can be used for CSI measurement and/or CSI reporting, thereby ensuring CSI performance.

It should be noted that, for the implementation of various operations in the embodiments illustrated in FIG. 9, reference can be made to the elaborations in the method embodiments above, which will not be repeated herein.

### VII. Exemplary Description of a Terminal Device

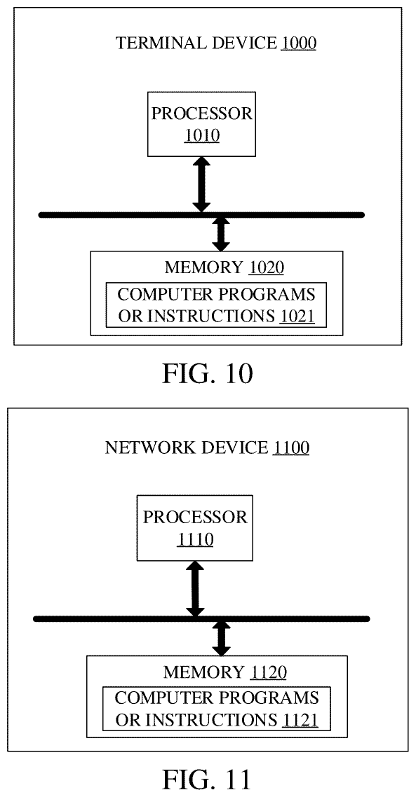

FIG. 10 is a schematic diagram of the structure of a terminal device according to embodiments of the disclosure. The terminal device 1000 includes a processor 1010, a memory 1020, and a communication bus configured to connect the processor 1010 and the memory 1020.

In some possible implementations, the memory 1020 includes but is not limited to a random access memory (RAM), a read-only memory (ROM), an erasable programmable read-only memory (EPROM), or a compact disc read-only memory (CD-ROM). The memory 1020 is configured to store program codes executed by the terminal device 1000 and data transmitted by the terminal device 1000.

In some possible implementations, the terminal device 1000 further includes a communication interface configured to receive and transmit data.

In some possible implementations, the processor 1010 may be one or more CPUs. When the processor 1010 is one CPU, the CPU may be a single-core CPU or a multi-core CPU.

In some possible implementations, the processor 1010 may be a baseband chip, a chip, a CPU, a general-purpose processor, a DSP, an ASIC, an FPGA, or other programmable logic devices, transistor logic devices, hardware components, or any combination thereof.

In specific implementation, the processor 1010 in the terminal device 1000 is configured to execute computer programs or instructions 1021 stored in the memory 1020 to: perform CSI measurement and/or CSI reporting according to a CSI reporting band, where the CSI reporting band is determined according to an active BWP and multiple frequency domain resources in a same time unit, and the multiple frequency domain resources include an uplink frequency domain resource and a downlink frequency domain resource.

As can be seen, in embodiments of the disclosure, the multiple frequency domain resources in the same time unit are considered on the basis of the active BWP, since there may be frequency domain resources in the active BWP that overlap with the uplink frequency domain resource in the multiple frequency domain resources in the same time unit. Since CSI measurement and/or CSI reporting involves downlink frequency domain resources, these overlapping frequency domain resources may be unavailable for CSI measurement and/or CSI reporting. That is, these overlapping frequency domain resources cannot be used for CSI measurement and/or CSI reporting.

In order to perform CSI measurement and/or CSI reporting considering the multiple frequency domain resources in the same time unit on the basis of the active BWP, in the disclosure, the CSI reporting band can be determined according to the active BWP and the multiple frequency domain resources in the same time unit, and then CSI measurement and/or CSI reporting can be performed according to the CSI reporting band. Since the determination of the CSI reporting band comprehensively considers the active BWP and the multiple frequency domain resources in the same time unit, the determined CSI reporting band can be used for CSI measurement and/or CSI reporting, thereby ensuring CSI performance.

It should be noted that, for the implementation of various operations, reference can be made to the corresponding elaborations of the method embodiments above. The terminal device 1000 may be configured to perform the foregoing method embodiments of the disclosure, which will not be repeated herein.

### VIII. Exemplary Description of a Network Device

FIG. 11 is a schematic diagram of a structure of a network device provided in embodiments of the disclosure. The network device 1100 includes a processor 1110, a memory 1120, and a communication bus configured to connect the processor 1110 and the memory 1120.

In some possible implementations, the memory 1120 includes but is not limited to a RAM, a ROM, a EPROM, or a CD-ROM. The memory 1120 is configured to store relevant instructions and data.

In some possible implementations, the network device 1100 further includes a communication interface configured to receive and transmit data.

In some possible implementations, the processor 1110 may be one or more CPUs. When the processor 1110 is one CPU, the CPU may be a single-core CPU or a multi-core CPU.

In some possible implementations, the processor 1110 may be a baseband chip, a chip, a CPU, a general-purpose processor, a DSP, an ASIC, an FPGA, or other programmable logic devices, transistor logic devices, hardware components, or any combination thereof.

In some possible implementations, the processor 1110 in the network device 1100 is configured to execute computer programs or instructions 1121 stored in the memory 1120 to: receive a CSI report, where the CSI report is performed according to a CSI reporting band, the CSI reporting band is determined according to an active BWP and multiple frequency domain resources in a same time unit, and the multiple frequency domain resources include an uplink frequency domain resource and a downlink frequency domain resource.

As can be seen, in embodiments of the disclosure, the multiple frequency domain resources in the same time unit are considered on the basis of the active BWP, since there may be frequency domain resources in the active BWP that overlap with the uplink frequency domain resource in the multiple frequency domain resources in the same time unit. Since CSI measurement and/or CSI reporting involves downlink frequency domain resources, these overlapping frequency domain resources may be unavailable for CSI measurement and/or CSI reporting. That is, these overlapping frequency domain resources cannot be used for CSI measurement and/or CSI reporting.

In order to perform CSI measurement and/or CSI reporting considering the multiple frequency domain resources in the same time unit on the basis of the active BWP, in the disclosure, the CSI reporting band can be determined according to the active BWP and the multiple frequency domain resources in the same time unit, and then CSI measurement and/or CSI reporting can be performed according to the CSI reporting band. Since the determination of the CSI reporting band comprehensively considers the active BWP and the multiple frequency domain resources in the same time unit, the determined CSI reporting band can be used for CSI measurement and/or CSI reporting, thereby ensuring CSI performance.

It should be noted that, for the implementation of various operations, reference can be made to the corresponding elaborations of the method embodiments above. The network device 1100 may be configured to perform the foregoing method embodiments of the disclosure, which will not be repeated herein.

### IX. Other Related Exemplary Descriptions

In some possible implementations, above method embodiments may be applied to or in a terminal device. That is, the execution entity of above method embodiments may be a terminal device, a chip, a chip module, or a module, etc., which is not limited herein.

In some possible implementations, above method embodiments may be applied to or in a network device. That is, the execution subject of above method embodiments may be a network device, a chip, a chip module, or a module, etc., which is not limited herein.

Embodiments of the disclosure further provide a chip. The chip includes a processor, a memory, and computer programs or instructions stored in the memory. The processor is configured to execute the computer programs or instructions to perform the operations of above method embodiments.

Embodiments of the disclosure further provide a chip module. The chip module includes a transceiver assembly and a chip. The chip includes a processor, a memory, and computer programs or instructions stored in the memory. The processor is configured to execute the computer programs or instructions to perform the operations of above method embodiments.

Embodiments of the disclosure further provide a computer-readable storage medium. The computer-readable storage medium is configured to store computer programs or instructions which, when executed, are operable to perform the operations of above method embodiments.

Embodiments of the disclosure further provide a computer program product. The computer program product includes computer programs or instructions which, when executed, are operable to perform the operations of above method embodiments.

Embodiments of the disclosure further provides a communication system including the terminal device and the network device above.

It should be noted that, for the sake of brevity, the foregoing embodiments are described as a series of action combinations. However, it will be appreciated by those skilled in the art that the disclosure is not limited to the sequence of actions described. According to embodiments of the disclosure, some steps may be performed in other orders or simultaneously. In addition, it will be appreciated by those skilled in the art that the embodiments described in the specification are preferable embodiments, and the actions, steps, modules, or units involved are not necessarily essential to the disclosure.

In the foregoing embodiments, the elaboration of each embodiment has its own emphasis. For the parts not described in detail in one embodiment, reference may be made to related elaborations in other embodiments.

The operations of the method or algorithm described in embodiments of the disclosure may be implemented by means of hardware, or may be implemented by executing software instructions by a processor. The software instructions can be implemented by corresponding software modules, which can be stored in a RAM, a flash memory, a ROM, an EPROM, an electrically EPROM (EEPROM), registers, hard disk, mobile hard disk, compact disc (CD)-ROM, or any other form of storage medium known in the art. An exemplary storage medium is coupled to the processor, such that the processor can read information from the storage medium and write information to the storage medium. The storage medium can also be a component of the processor. The processor and the storage medium may be located in an ASIC. In addition, the ASIC can be located in a terminal device or a management device. The processor and the storage medium may also be present as discrete components in the terminal device or the management device.

Those skilled in the art will appreciate that, all or part of functions described in embodiments of the disclosure can be implemented through software, hardware, firmware, or any other combination thereof. When implemented by software, all or part of the functions can be implemented in the form of a computer program product. The computer program product includes one or more computer instructions. When the computer instructions are applied and executed on a computer, all or part of the operations or functions of embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disc, a hard disc, or a magnetic tape), an optical medium (such as a digital video disc (DVD)), or a semiconductor medium (such as a solid state disk (SSD)), etc.

Each module/unit in various devices or products described in the foregoing embodiments may be a software module/unit or a hardware module/unit, or some may be a software module/unit and some may be a hardware module/unit. For example, with regard to various devices or products applied to or integrated into a chip, various modules/units included therein may all be realized by means of hardware such as a circuit. Alternatively, at least some of the modules/units may be realized by means of a software program run on a processor integrated into the chip, and the rest (if any) modules/units may be implemented by means of hardware such as a circuit. The same also applies to various devices or products applied to or integrated into a chip module or various devices or products applied to or integrated into a terminal device.

The objectives, technical solutions, and advantages of embodiments of the disclosure are described in detail in the foregoing implementations. It may be appreciated that, the foregoing elaborations are merely some implementations of embodiments of the disclosure, but are not intended to limit the protection scope of embodiments of the disclosure. Any modifications, equivalent replacements, improvements, and the like made based on the technical solutions of embodiments of the disclosure shall all fall within the protection scope of embodiments of the disclosure.

1. A communication method, comprising:
performing channel state information (CSI) measurement and/or CSI reporting according to a CSI reporting band, wherein the CSI reporting band is determined according to an active bandwidth part (BWP) and a plurality of frequency domain resources in a same time unit, and the plurality of frequency domain resources comprise an uplink frequency domain resource and a downlink frequency domain resource.

2. The method of claim 1, wherein the CSI reporting band being determined according to the active BWP and the plurality of frequency domain resources in the same time unit comprises:
the CSI reporting band being determined according to an unavailable frequency domain resource and/or an available frequency domain resource, wherein
the unavailable frequency domain resource is a frequency domain resource in the active BWP that does not overlaps with the downlink frequency domain resource in the plurality of frequency domain resources, and
the available frequency domain resource is a frequency domain resource in the active BWP that overlaps with the downlink frequency domain resource in the plurality of frequency domain resources.

3. The method of claim 2, wherein the CSI reporting band being determined according to the unavailable frequency domain resource and/or the available frequency domain resource comprises:
the unavailable frequency domain resource in the active BWP being excluded, and the CSI reporting band being determined according to the available frequency domain resource.

4-5. (canceled)

6. The method of claim 2, wherein the CSI reporting band being determined according to the unavailable frequency domain resource and/or the available frequency domain resource comprises:
the CSI reporting band being determined according to the unavailable frequency domain resource and the available frequency domain resource without excluding the unavailable frequency domain resource in the active BWP.

7. The method of claim 6, wherein a subband in the CSI reporting band is determined according to the unavailable frequency domain resource and the available frequency domain resource, the subband in the CSI reporting band comprises an available subband, and
at least one RBs in the available subband overlaps with the downlink frequency domain resource in the plurality of frequency domain resources, and/or all RBs in the available subband overlap with the downlink frequency domain resource in the plurality of frequency domain resources.

8. The method of claim 6, wherein a subband in the CSI reporting band is determined according to the unavailable frequency domain resource and the available frequency domain resource, the subband in the CSI reporting band comprises an available subband and an unavailable subband,
at least one RBs in the available subband overlaps with the downlink frequency domain resource in the plurality of frequency domain resources, and/or all RBs in the available subband overlap with the downlink frequency domain resource in the plurality of frequency domain resources, and
the unavailable subband is a subband other than the available subband in the CSI reporting band.

9. The method of claim 7, wherein the available subband in the CSI reporting band is used to report a CSI report.

10-13. (canceled)

14. A communication method, comprising:
receiving a channel state information (CSI) report, wherein the CSI report is performed according to a CSI reporting band, the CSI reporting band is determined according to an active bandwidth part (BWP) and a plurality of frequency domain resources in a same time unit, and the plurality of frequency domain resources comprise an uplink frequency domain resource and a downlink frequency domain resource.

15. The method of claim 14, wherein the CSI reporting band being determined according to the active BWP and the plurality of frequency domain resources in the same time unit comprises:
the CSI reporting band being determined according to an unavailable frequency domain resource and/or an available frequency domain resource, wherein
the unavailable frequency domain resource is a frequency domain resource in the active BWP that does not overlap with the downlink frequency domain resource in the plurality of frequency domain resources, and
the available frequency domain resource is a frequency domain resource other than the unavailable frequency domain resource in the active BWP.

16. The method of claim 15, wherein the CSI reporting band being determined according to the unavailable frequency domain resource and/or the available frequency domain resource comprises:
the unavailable frequency domain resource in the active BWP being excluded, and the CSI reporting band being determined according to a subband in the available frequency domain resource.

17-18. (canceled)

19. The method of claim 15, wherein the CSI reporting band being determined according to the unavailable frequency domain resource and/or the available frequency domain resource comprises:
the CSI reporting band being determined according to the unavailable frequency domain resource and the available frequency domain resource without excluding the unavailable frequency domain resource in the active BWP.

20. The method of claim 19, wherein a subband in the CSI reporting band is determined according to the unavailable frequency domain resource and the available frequency domain resource, the subband in the CSI reporting band comprises an available subband, and
at least one RBs in the available subband overlaps with the downlink frequency domain resource in the plurality of frequency domain resources, and/or all RBs in the available subband overlap with the downlink frequency domain resource in the plurality of frequency domain resources.

21. The method of claim 19, wherein a subband in the CSI reporting band is determined according to the unavailable frequency domain resource and the available frequency domain resource, the subband in the CSI reporting band comprises an available subband and an unavailable subband,
at least one RBs in the available subband overlaps with the downlink frequency domain resource in the plurality of frequency domain resources, and/or all RBs in the available subband overlap with the downlink frequency domain resource in the plurality of frequency domain resources, and
the unavailable subband is a subband other than the available subband in the CSI reporting band.

22. The method of claim 20, wherein the available subband in the CSI reporting band is used to report a CSI report.

23-52. (canceled)

53. A terminal device comprising a processor and a memory configured to store computer programs or instructions, wherein the processor is configured to execute the computer programs or instructions to:
perform channel state information (CSI) measurement and/or CSI reporting according to a CSI reporting band, wherein the CSI reporting band is determined according to an active bandwidth part (BWP) and a plurality of frequency domain resources in a same time unit, and the plurality of frequency domain resources comprise an uplink frequency domain resource and a downlink frequency domain resource.

54-56. (canceled)

57. The terminal device of claim 53, wherein the CSI reporting band being determined according to the active BWP and the plurality of frequency domain resources in the same time unit comprises:
the CSI reporting band being determined according to an unavailable frequency domain resource and/or an available frequency domain resource, wherein
the unavailable frequency domain resource is a frequency domain resource in the active BWP that does not overlap with the downlink frequency domain resource in the plurality of frequency domain resources, and
the available frequency domain resource is a frequency domain resource in the active BWP that overlaps with the downlink frequency domain resource in the plurality of frequency domain resources.

58. The terminal device of claim 57, wherein the CSI reporting band being determined according to the unavailable frequency domain resource and/or the available frequency domain resource comprises:
the unavailable frequency domain resource in the active BWP being excluded, and the CSI reporting band being determined according to the available frequency domain resource.

59. The terminal device of claim 57, wherein the CSI reporting band being determined according to the unavailable frequency domain resource and/or the available frequency domain resource comprises:
the CSI reporting band being determined according to the unavailable frequency domain resource and the available frequency domain resource without excluding the unavailable frequency domain resource in the active BWP.

60. The terminal device of claim 59, wherein a subband in the CSI reporting band is determined according to the unavailable frequency domain resource and the available frequency domain resource, the subband in the CSI reporting band comprises an available subband, and
at least one RB in the available subband overlaps with the downlink frequency domain resource in the plurality of frequency domain resources, and/or all RBs in the available subband overlap with the downlink frequency domain resource in the plurality of frequency domain resources.

61. The terminal device of claim 59, wherein a subband in the CSI reporting band is determined according to the unavailable frequency domain resource and the available frequency domain resource, the subband in the CSI reporting band comprises an available subband and an unavailable subband,
at least one RB in the available subband overlaps with the downlink frequency domain resource in the plurality of frequency domain resources, and/or all RBs in the available subband overlap with the downlink frequency domain resource in the plurality of frequency domain resources, and
the unavailable subband is a subband other than the available subband in the CSI reporting band.
